(19) United States
(12) Patent Application Publication
(10) Pub. No.: US 2026/0261129 A1
(43) Pub. Date: Sep. 3, 2026

(54) ACTIVATION OF NODES IN A DISTRIBUTED ENERGY STORAGE, DES, SYSTEM

(71) Applicant: Elisa Oyj, Helsinki (FI)

(72) Inventors: Simon HOLMBACKA, Helsinki (FI); Hannu KOKKO, Helsinki (FI); Jukka-Pekka SALMENKAITA, Helsinki (FI)

(21) Appl. No.: 19/162,424

(22) PCT Filed: Mar. 27, 2024
(86) PCT No.: PCT/FI2024/050148

§ 371 Date: Sep. 5, 2025

(30) Foreign Application Priority Data
Apr. 5, 2023 (FI) 20235386

(51) Int. Cl. H02J 3/38; H02J 13/12

(52) U.S. Cl. CPC H02J 3/381; H02J 13/12

(57) ABSTRACT

A computer implemented method for activation of nodes in a distributed energy storage, DES, system, wherein the DES system comprises a plurality of nodes, each node comprising one or more battery units. The method comprises defining (310) a ruleset for the DES system, wherein the ruleset comprises for each node first rules for a more preferred combination of operating parameters and second rules for at least one less preferred combination of operating parameters; detecting (320) a required capacity; and responsively activating (330) nodes by using a combination of operating parameters derived based on the respective first rules until the required capacity is fulfilled or until all available nodes have been activated.

### TECHNICAL FIELD

The present disclosure generally relates to management of distributed energy storage, DES, systems.

### BACKGROUND

This section illustrates useful background information without admission of any technique described herein representative of the state of the art.

A distributed energy storage (DES) system is a pool of spatially distributed nodes controlled by a centralized control system. The nodes may be distributed over a vast geographical area. The nodes can be powered either by the electric grid or by a battery unit connected to the node. The battery units may be resources maintained for example for emergency energy backup purposes, such as backup batteries of a wireless communication network. Additionally or alternatively, the battery units may be resources owned by households or small and medium sized companies or other smaller scale operators. The battery units of a DES system can be used for forming a virtual power plant (VPP) comprising a plurality of spatially distributed nodes. In this way a larger capacity may be built by pooling together smaller scale resources. As backup batteries are not constantly used, the battery units of the nodes of the DES can be used for further optimization purposes e.g. through the VPP.

Such VPPs may participate in balancing of electric grid or in intraday trading market. Transmission system operators (TSO) offer reserve markets where reserve providers, such as VPP, can offer energy capacity for grid balancing purposes.

Now, there are provided some new considerations concerning management of distributed energy storage systems for the purpose of enabling participation in balancing of electric grid.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a computer implemented method for activation of nodes in a distributed energy storage, DES, system, wherein the DES system comprises a plurality of nodes, each node comprising one or more battery units. The method comprises
defining a ruleset for the DES system, wherein the ruleset comprises for each node first rules for a more preferred combination of operating parameters and second rules for at least one less preferred combination of operating parameters;
detecting a required capacity; and
responsively activating nodes by using a combination of operating parameters derived based on the respective first rules until the required capacity is fulfilled or until all available nodes have been activated.

In some example embodiments, the method further comprises detecting a need for additional capacity and responsively adjusting the combination of operating parameters of one or more activated nodes based on the respective second rules until the additional capacity is reached.

In some example embodiments, detecting the need for additional capacity comprises detecting that the required capacity is not fulfilled by the activated nodes.

In some example embodiments, the method further comprises detecting a need for additional capacity and responsively first increasing the amount of activated nodes, if available, and then adjusting the combination of operating parameters of one or more activated nodes based on the respective second rules until the additional capacity is reached.

In some example embodiments, detecting the need for additional capacity comprises detecting a change in the required capacity.

In some example embodiments, the first rules and/or the second rules comprise separate rules for charging battery unit(s) of the respective node and for discharging battery unit(s) of the respective node.

In some example embodiments, the required capacity is capacity needed for balancing of electric grid.

In some example embodiments, the required capacity is capacity needed for load shifting.

In some example embodiments, the operating parameters comprise one or more of: rectifier voltage, rectifier current, rectifier ramp-up settings, rectifier ramp-down settings, battery current.

In some example embodiments, the combination of operating parameters derived based on the first rules and/or the second rules dynamically vary based on real time conditions.

In some example embodiments, the real time conditions relate to one or more of: temperature, battery properties, and rectifier properties.

In some example embodiments, the battery properties comprise one or more of: C-rate, state of charge, state of health, duration of possible activation.

According to a second example aspect of the present invention, there is provided an apparatus comprising means for performing the method of the first aspect or any related embodiment. The means may comprise a processor and a memory including computer program code, and wherein the memory and the computer program code are configured to, with the processor, cause the performance of the apparatus.

According to a third example aspect of the present invention, there is provided a computer program comprising computer executable program code which, when executed by a processor, causes an apparatus to perform the method of the first aspect or any related embodiment.

According to a fourth example aspect there is provided a computer program product comprising a non-transitory computer readable medium having the computer program of the third example aspect stored thereon.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIG. 2 shows a block diagram of an apparatus according to an example embodiment;

FIG. 3 shows logical components of an arrangement according to an example embodiment; and

FIGS. 4-13 show example cases.

### DETAILED DESCRIPTION

In the following description, like reference signs denote like elements or steps.

Various embodiments of present disclosure provide mechanisms to manage a distributed energy storage, DES, system, wherein the DES system comprises a plurality of nodes. The nodes are spatially distributed entities that can be powered either by the electric grid or by a battery unit connected to the node. The battery units may be resources maintained for example for emergency energy backup purposes, such as backup batteries of a wireless communication network. Additionally or alternatively, the battery units may be resources owned by households or small and medium sized companies or other smaller scale operators. As an alternative non-limiting example, the battery units may be intended for storing energy from local renewable sources such as solar panels and/or wind generators or even from a fuel-operated genset. As yet another alternative or additional non-limiting example, the intended use of the battery units is optimization of self-consumption. The node may be a hybrid system using multiple energy sources.

In general, the battery units in this disclosure refer to battery units that are able to handle regular charge and discharge cycles. For example, lithium based batteries are such battery units. In more detail, one or more of the following battery technologies may be represented in the DES nodes: lithium-nickel-cobalt, NCA, lithium-iron-phosphate, LFP, lithium-nickel-manganese-cobalt, NMC, flow batteries, and solid-state batteries. The battery units may have different properties with regard to price, durability, physical size and wear depending for example on the battery technology and storage capacity.

In general, lithium based batteries should not regularly exceed extreme low or high charge values. For example, state of charge below 5% or above 95% should be avoided. Such limitations should be taken into account in usage of the lithium-ion batteries to avoid increased wear of the batteries.

Battery units of a DES system can be used for forming a virtual power plant (VPP) comprising a plurality of spatially distributed nodes. In this way a larger capacity may be built by pooling together smaller scale resources. The battery units of the nodes can be used for temporarily feeding energy to the electric grid to balance the electric grid and/or for temporarily storing surplus energy from the electric grid to balance the electric grid and/or for further optimization purposes through the VPP.

Such VPPs may participate in balancing of electric grid or in intraday trading market. Transmission system operators (TSO) offer reserve markets where reserve providers, such as VPPs, can offer energy capacity for grid balancing purposes.

Frequency balancing of electric grid may be arranged for example using automatic Frequency Restoration Reserve, aFRR, or Frequency Containment Reserve, FCR, capacity market. aFRR is a centralized automatically activated reserve. Its activation is based on a power change signal calculated on the basis of the frequency deviation in the Nordic synchronized area. Its purpose is to return the frequency to the nominal value. FCR is an active power reserve that is automatically controlled based on the frequency deviation. FCR may be Frequency Containment Reserve for Normal Operation, FCR-N, or Frequency Containment Reserve for Disturbances, FCR-D. Their purpose is to contain the frequency during normal operation and disturbances.

The frequency balancing may comprise up regulation and/or down regulation. Up regulation means increasing power production or decreasing consumption. For up regulation the battery units of the DES system may be arranged to feed energy to the electric grid. Down regulation means decreasing power production or increasing consumption. For down regulation, the battery units of the DES system may be arranged to store energy from the electric grid.

In order to participate in the grid balancing, the DES nodes need to be activated upon detecting a balancing need. The balancing need may be automatically detected or the balancing need may be signalled in a balancing request. The balancing need may relate to up regulation or down regulation.

Various embodiments of present disclosure provide a centralized control system for managing a DES system so that the DES system can be used for participating in frequency balancing of electric grid e.g. in the aFRR and/or FCR capacity market and/or for further optimization purposes such as optimizing state of charge of the battery units of the DES system or load shifting in the DES system.

Such control task is not a straightforward problem to solve as there are likely thousands of individual battery units with individual and heterogenous properties with regard to power characteristics (power effectiveness and losses), battery health and degradation of battery health, risks of equipment failure, effects and risks caused by temperature changes etc. For this reason, beneficial or preferred operating conditions and parameters, such as rectifier voltage, rectifier current, battery current etc, of different battery units may vary.

In various embodiments of present disclosure, there is provided a centralized control system that aims at using preferred operating parameters for each node or battery unit of the DES system.

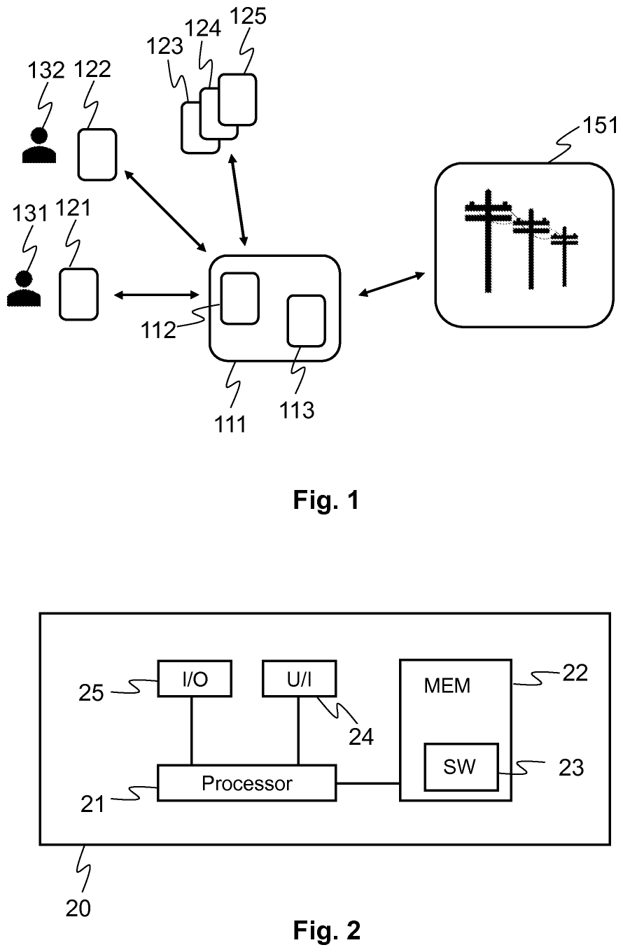

FIG. 1 schematically shows an example scenario according to an embodiment. The scenario shows a DES system formed of nodes 121-125, each including one or more battery units. The nodes 121-125 may be located at different geographical locations, but equally there may be plurality of nodes at the same location. FIG. 1 shows the nodes 123-125 at the same location and the nodes 121 and 122 individually at different locations. The nodes 121 and 122 are owned by individuals 131 and 132, respectively. The nodes 123-125 are co-located nodes owned for example by a small company. In practice, each node may have individual IP address to enable remote control of the nodes. In an example, co-located nodes may require multiple co-located IP addresses for sending control messages to the nodes. Alternatively, co-located nodes may be controlled through one IP address that can be used for distributing control messages to the co-located nodes. The battery units of the nodes 121-125 may be intended for emergency backup purposes, but this is not mandatory. In an example embodiment, the battery units of the nodes are backup batteries of a wireless communication network. In another example embodiment, the battery units of the nodes are battery units of households or battery units of buildings. In an example embodiment, the nodes are co-located with an energy production unit, such as solar or wind farm. It is to be noted that this is only a non-limiting illustrative example and in practical implementations many different setups are possible.

Further, the scenario shows a control system 111. The control system 111 may control the nodes 121-125 of the DES system to operate as a virtual power plant. Still further, FIG. 1 shows an electric grid 151.

The control system 111 is configured to implement at least some example embodiments of present disclosure to manage the nodes 121-125 of the DES system. For this purpose, the control system 111 is operable to interact with the nodes 121-125, with the battery units of the nodes 121-125, and/or equipment associated thereto. The control system 111 comprises a first interface 112 for such interaction. Communication over the first interface 112 is implemented for example using Simple Network Management Protocol (SNMP). Additionally, the control system 111 is operable to interact with the electric grid 151 or equipment associated thereto to coordinate participation in frequency balancing of the electric grid. The control system 111 comprises a second interface 113 for this purpose.

The operator of the DES system may receive compensation based on the frequency balancing carried out for the electric grid. The compensation may depend on actual activation of frequency balancing and/or on reserving capacity for the possible frequency balancing needs. Further, there may be penalty if the DES system fails to fulfil the frequency balancing commitments. The DES system may fail to fulfil the frequency balancing commitment by not being able to activate enough capacity in up or down direction and/or by not being able perform the necessary activations fast enough. In general, there may be an incentive to fulfil the commitments made. Sometimes failing to fulfil the commitments made may be acceptable, though. For example, if it is clear, it is not possible to fully fulfil the commitment, it may be chosen not to activate at all. In principle, it may be considered that it is better to activate 0% of the resources and fail than to activate 80% of the resources and fail.

FIG. 2 shows a block diagram of an apparatus 20 according to an embodiment. The apparatus 20 is for example a general purpose computer, cloud computing environment or some other electronic data processing apparatus. The apparatus 20 can be used for implementing at least some embodiments of present disclosure. That is, with suitable configuration the apparatus 20 is suited for operating for example as the control system 111 of FIG. 1.

The apparatus 20 comprises a communication interface 25; a processor 21; a user interface 24; and a memory 22. The apparatus 20 further comprises software 23 stored in the memory 22 and operable to be loaded into and executed in the processor 21. The software 23 may comprise one or more software modules and can be in the form of a computer program product.

The processor 21 may comprise a central processing unit (CPU), a microprocessor, a digital signal processor (DSP), a graphics processing unit, or the like. FIG. 2 shows one processor 21, but the apparatus 20 may comprise a plurality of processors.

The user interface 24 is configured for providing interaction with a user of the apparatus. Additionally or alternatively, the user interaction may be implemented through the communication interface 25. The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 may comprise for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories. The memory 22 may serve the sole purpose of storing data, or be constructed as a part of an apparatus 20 serving other purposes, such as processing data.

The communication interface 25 may comprise communication modules that implement data transmission to and from the apparatus 20. The communication modules may comprise a wireless or a wired interface module(s) or both. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. The communication interface 25 may support one or more different communication technologies. The apparatus 20 may additionally or alternatively comprise more than one of the communication interfaces 25.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like.

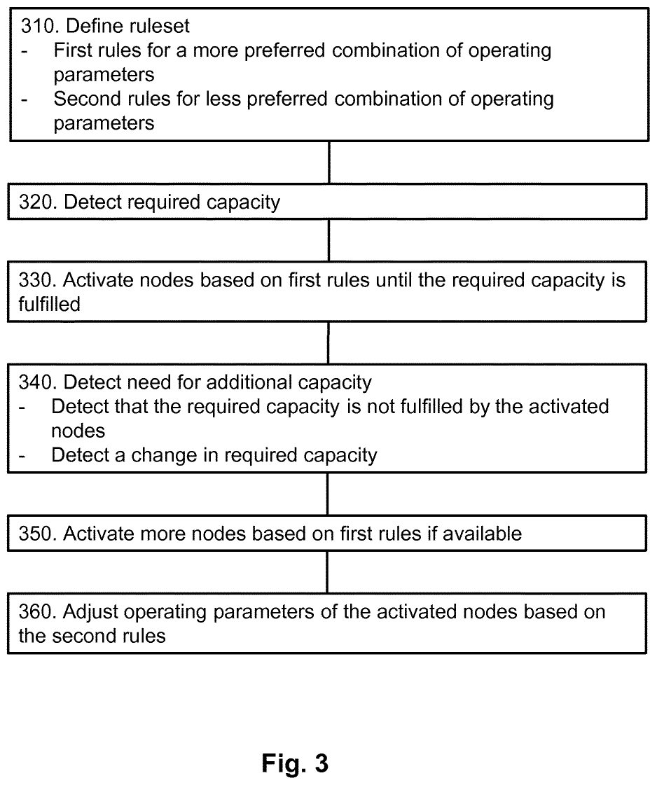

FIG. 3 shows a flow chart according to example embodiments. FIG. 3 illustrates processes comprising various possible steps including some optional steps while also further steps can be included and/or some of the steps can be performed more than once. The processes may be implemented in the control system 111 of FIG. 1 and/or in the apparatus 20 of FIG. 2. The processes are implemented in a computer program code and does not require human interaction unless otherwise expressly stated. It is to be noted that the processes may however provide output that may be further processed by humans and/or the processes may require user input to start.

The processes of FIG. 3 concern activation of nodes in a distributed energy storage, DES, system. The DES system comprises a plurality of nodes and each node comprises one or more battery units. The processes comprise the following steps:

310. A ruleset is defined for the DES system. The ruleset comprises for each node first rules for a more preferred combination of operating parameters and second rules for at least one less preferred combination of operating parameters. The terms more preferred combination and less preferred combination may be considered as different names of the combinations to distinguish the combinations from each other. Additionally or alternatively, the terms more preferred combination and less preferred combination may be considered to indicate preference of the combinations in relation to each other.

The operating parameters concern settings of the nodes or respective battery units. The operating parameters may comprise one or more of: rectifier voltage, rectifier current, rectifier ramp-up settings, rectifier ramp-down settings, battery current, for example. Further details of the rules are discussed later in this document.

The ramp-up settings and the ramp-down settings of the rectifier refer to settings that are used when the rectifier will increase or decrease the voltage after a command has been given to it. The settings may concern how fast the voltage is altered. For example, if the rectifier is on a “discharge” mode at 46V and it gets a “charge” command, then the rectifier will ramp up the voltage from 46V to 54V at a certain speed. The speed may be for example 1 second or 10 seconds depending on the ramp-up settings. Slow ramp-up (or ramp-down) may be beneficial for power equipment longevity.

In an embodiment the first rules and/or the second rules include separate rules for charging battery unit(s) of the respective node and for discharging battery unit(s) of the respective node. That is, different rules are to be applied in a downregulation case and in an upregulation case, for example.

320. A required capacity is detected. The capacity may be required for load shifting or for balancing of electric grid. The required capacity may be detected based on a request to activate previously allocated capacity. The request to activate may be received from electric grid operator and it may concern activation of capacity defined in a previously submitted bid.

330. Activation of the required capacity is started, and nodes of the DES system are activated based on the first rules until the required capacity is fulfilled. More specifically, nodes are activated by using a combination of operating parameters derived based on the respective first rules until the required capacity is fulfilled. According to an alternative definition, the nodes are activated by using a combination of operating parameters derived based on the respective first rules until the required capacity is fulfilled or until all available nodes have been activated, whichever comes first.

340. Thereafter, a need for additional capacity may be detected. For example, the required capacity is not completely fulfilled by the activation in step 330 and this may be detected. Additionally or alternatively, a change in the required capacity may be detected.

350. Responsive to detecting the need for additional capacity, the amount of activated nodes may be first increased the same way as disclosed in step 330 (i.e. based on the first rules) if all available nodes have not yet been activated. that is, more nodes may be activated if available. This option is suitable for example in a situation where a change in the required capacity is detected.

360. Additionally or alternatively, the combination of operating parameters of one or more activated nodes may be adjusted based on the respective second rules, if all available nodes have already been activated. This option is suitable for example in a situation where activation of all available nodes does not suffice for reaching the required capacity or the detected additional capacity.

The steps 350 and/or 360 are performed until the additional capacity is reached.

The example discussed in connection with FIG. 3 concerns first rules for more preferred combination of operating parameters and second rules for less preferred combination of operating parameters. It is to be noted that in addition, further rules may be provided and used in priority order. There may be for example third rules for even less preferred combination of operating parameters and such third rules are applied if further capacity is still required after having applied the second rules for all available nodes of the DES system.

Further, it is to be noted that in any phase of present disclosure there may be one or more nodes of the DES system that a blacklisted from activation and therefore not available for being activated.

In various embodiments of present disclosure, operating parameters are derived based on the rules (e.g. the first rules of the second rules). The process of deriving the operating parameters may vary dynamically based on real time conditions. The real time conditions may relate to one or more of: temperature, battery properties, and rectifier properties, for example. Node or battery unit temperature can have an adverse effect on the degree of wear of the battery unit. Such adverse effects related to charge or discharge may be avoided by throttling the activation of nodes or battery units with very high or very low temperatures. The battery properties may comprise one or more of: C-rate, state of charge, state of health, duration of possible activation, for example. Battery chemistry may have an impact on the degree of wear of the battery unit. Certain chemistries can handle high current better than others, for example. Any power electronics will wear quicker if more current is passed through the power mosfets. Component quality, warranty or other items can indicate the degree of optimal throttling for the node. The rules may take into account also other variables that may have an impact on operation of the battery units.

For example one or more of the following may be taken into account in the rules:
Battery longevity
   Low C-rate (charging/discharging power in relation to battery capacity) preferred over high C-rate
   Temperature: Charging settings (e.g. charging speed) may vary depending on temperature. For example, if it is very cold or very hot, the battery should be charged slower.
   Optimization of SoC-level: middle area (e.g. 30-70%) preferred over extremes (very high or very low SoC)
   Optimization of activation duration: medium/long activations preferred over very short activations
   Avoid activation with negligible power levels
Power effectiveness
   Boost charging
   Optimization/throttling the rectifier current
   Battery charge limitations
Equipment fault risk
   Using power equipment at a moderate capacity rather than at a full capacity all the time is likely to result in less frequent equipment failures.
Temperature control
   Effects of high or very low temperature: may cause fault risk and limit usage of the nodes
   Temperature effects on charging/discharging: variation in behavior if preheating in use, no preheating in use
   Effects of usage of the battery units causing temperature changes causing need for control
   Temperature characteristic of geographical area: very high temperature or very low temperature may cause nodes to have less leeway
   Weather forecasts: e.g. effects of expected heatwaves, forest fires etc
   Effects of heating/cooling/air conditioning inside equipment cabinet: If heating/cooling/air conditioning is available, it is possible to control the temperature, but if these are not available, the temperature likely follows the outside temperature and is hot when it is hot outside and cold when it is cold outside.

If the rules have multiple criteria that are considered (e.g. C-rate and SoC-level) the different criteria may have scoring weights, so that multiple criteria can be considered jointly. The weights can be determined based on expert evaluation, manufacturer recommendations, results from simulations, results from machine learning models analysing real-life behaviour of many nodes in different conditions.

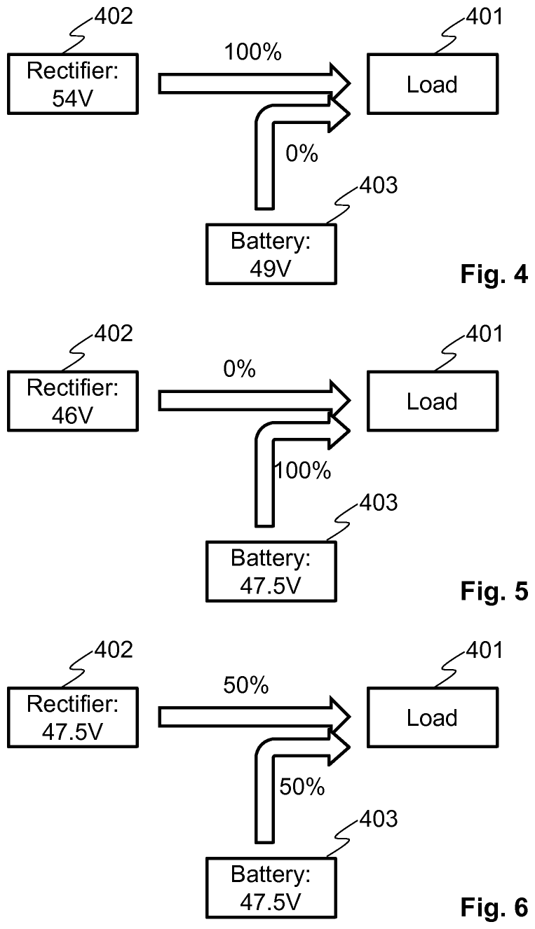

The following discusses some examples of different operating parameters in example cases shown in FIGS. 4-13. Depending on the context and operating environment, the operating parameters of the example cases may relate to the more preferred operating parameters or the less preferred operating parameters of a node. If the example case results in decreasing the battery voltage, the respective operating parameters may be seen as an example of less preferred operating parameters if there is desire to maintain the battery voltage. On the other hand, the same operating parameters may be seen as an example of more preferred operating parameters if there is no need to maintain the battery voltage or if there is desire to reduce battery voltage. It is clear that there may be multiple different settings of the more preferred operating parameters and less preferred operating parameters. The example cases of FIGS. 4-13 merely show the effect of different operating parameters without restricting the scope of present disclosure to these examples.

The FIGS. 4-13 comprise a load 401, a rectifier 402 and a battery 403.

FIGS. 4-6 relate to rectifier voltage control. By controlling the rectifier voltage, it is possible to alter the “amount” of discharge of the battery unit to be less than 100%.

FIG. 4 shows a nominal state where the rectifier 402 is operating at 54V and the battery 403 is operating at about 49V. Since the rectifier voltage is higher than the battery voltage, no current at all will flow from the battery 403 to the load 401.

In FIG. 5, the rectifier voltage has been lowered to 46V and the battery voltage is about 47.5 V, i.e. the rectifier voltage is set to be lower than the battery voltage. As the battery voltage is higher than the rectifier voltage, 100% of the current to the load 401 is flowing from the battery 402, and the battery voltage drops a bit due to the load.

In FIG. 6, the rectifier voltage has been lowered to 47.5V, i.e. the rectifier voltage has been lowered a bit less than in FIG. 5. the battery voltage is about 47.5 V. As the battery voltage is roughly the same as the rectifier voltage, the load 401 draws current both from the rectifier 402 and form the battery 403. The amount of current need not be exactly the same from the rectified and the battery, though.

With regard to the voltage control examples it is to be noted that if rectifier voltage is set to e.g. 46V and the battery would fail for some reason, the power unit will not nevertheless fail because the rectifier will “catch” the load using the lower voltage.

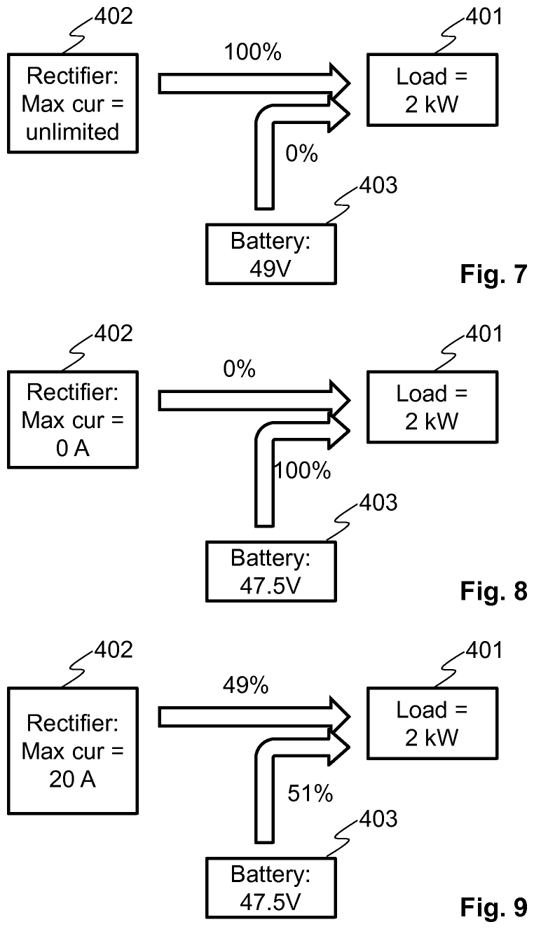

FIGS. 7-10 relate to rectifier current control. By controlling the rectifier current, it is possible to alter the “amount” of charge and discharge of the battery unit to be less than 100%.

FIG. 7 shows a nominal state where the rectifier 402 has no maximum current limitation (or such limit is very high and does not have any other impact than protecting the rectifier from excess usage). The rectifier takes the full load of 2 kW of the load 401.

In FIG. 8, the rectifier maximum current has been set to 0 A. The rectifier 402 cannot operate at all and the battery 403 takes the full load of 2 kW of the load 401.

In FIG. 9, the rectifier maximum current has been set to 20 A (which is about 1 kW at 48V). This means that the rectifier 402 can provide about half of the full load of 2 kW of the load 401 and the battery 403 will provide the remaining power. The battery 403 cannot be charged as the current limit of the rectifier 402 is too low.

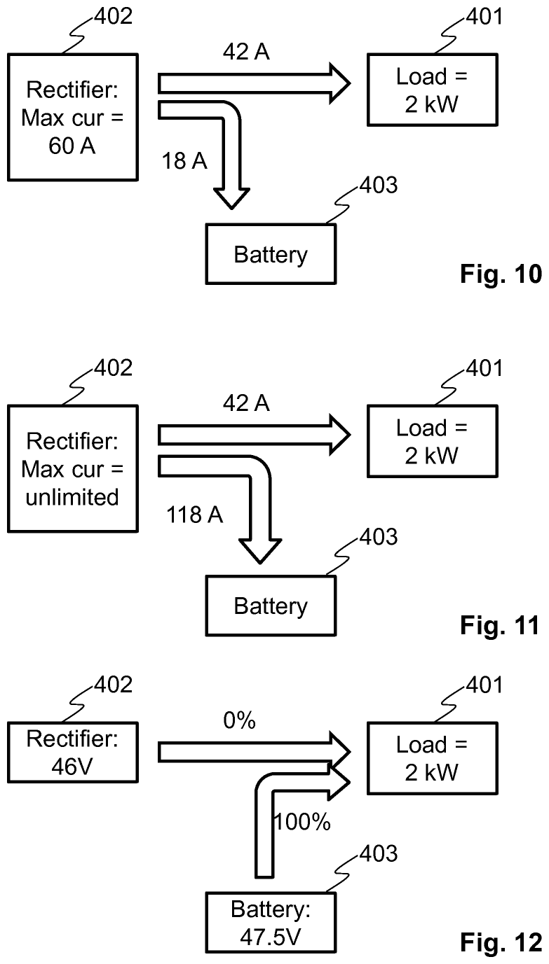

In FIG. 10, the rectifier maximum current has been set to 60 A and the system is set to charge the battery 403 in addition to supplying power to the load 401. The load 401 is 2 kW which takes about 42 A. As the rectifier has the current limit on 60 A, the battery 403 can charge with max 18 A.

If the battery 403 is set to charge, then the rectifier 402 will first provide power to the load 401 as far as the current limit allows, and the rest will be used for charging the battery 403.

The rectifier current control mechanisms may suit for example the FFR market.

FIGS. 11-13 relate to battery current control. By controlling the battery current, it is possible to alter the “amount” of charge of the battery unit to be less than 100%.

FIG. 11 shows a state where the rectifier 402 has no maximum current limitation (or such limit is very high and does not have any other impact than protecting the rectifier from excess usage). In this case, if the battery is set to charge, the battery will charge as fast as the rectifier maximum capacity will allow. The load 401 is 2 kW which takes about 42 A. If there are 4 rectifiers each with 40 A capacity, then the charging speed of the battery is 4*40 A−42 A=118 A.

In FIG. 12, which is similar to the example case of FIG. 5, the rectifier voltage control has been activated and the rectifier voltage is lower than the battery voltage. Hence it is not possible to charge the battery 403 and it does not matter what the battery charge limit is.

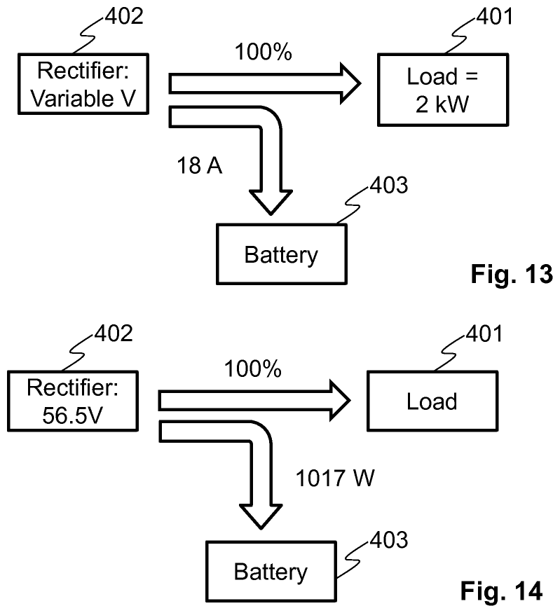

In FIG. 13, the rectifier 402 has a variable voltage. The rectifier voltage is adjusted according to the load. In this case, the rectifier supplies power to the load 401 and additionally the rectifier voltage allows a current of 18 A to charge the battery. The charge current available for the battery 403 is throttled depending on how low the variable voltage is.

With regard to the battery current control examples, it is to be noted that if the battery limit is set to some value lower than its max value and the battery would fail for some reason, power unit will not be affected because the battery charge limit only affects the charging of the battery and not supply to the load.

FIG. 14 relates to boosting charging of the battery. By this feature, it is possible to increase the charging power.

In a nominal state as shown in FIG. 5, the rectifier 402 is operating at 54V and the battery 403 is operating at about 49V.

In FIG. 14, the rectifier voltage has been temporarily increased to 56.5V and the battery is set to charge at 18 A. The total charging power is higher because of the higher voltage compared to a standard charge at 54 V. In this example the total charging power is 18 A*56.5V=1017 W. The battery 403 can therefore charge faster due to the higher power output of the rectifier.

It is to be noted that the boost charge feature may not suit all use cases as continuous usage may cause additional wear of the battery.

The rules of various embodiments may be composed of different algorithms and different types of logic may be used depending on the situation.

Simple heuristics can be used to determine the activation throttling for example as follows:

```
- If (temperature > t_high) and BatteryType = NMC, then
  ∘ Throttle_discharge = 20%
  ∘ Throttle_charge = 50%
- If (temperature > t_high) and BatteryType = LFP, then
  ∘ Throttle_discharge = 0%
  ∘ Throttle_charge = 10%
- If (temperature < t_low) and BatteryType != LeadAcid, then
  ∘ Throttle_discharge = 50%
  ∘ Throttle_charge = 80%
```

The values for the t_high and t_low may be chosen depending on the implementation. The values may be chosen may be made by an expert and/or the values may be derived based on history information and/or battery properties.

Additionally or alternatively, fuzzy logic style functions may be used for example as follows:
The membership functions are the inputs normalized to numerical values and the output membership function is the amount of throttling recommended.
Rules are made in a matrix format where an example of the charge throttling amount is provided as function of temperature, warranty and chemistry.

A simplified rule engine version may have cost values defined for each variable individually or as combinations. Then prioritization of operating parameters can be done very fast by selecting settings with least cost value first, and then proceeding to settings with higher cost if more effective activation is required. That is, the least cost value option may be used as the first rules of various embodiments and higher cost value option may be used as the second, third, fourth etc. rules of various embodiments.

Without in any way limiting the scope, interpretation, or application of the appended claims, a technical effect of one or more of the example embodiments disclosed herein is improved management of a DES system or a virtual power plant, VPP. Various embodiments help taking into account the heterogeneous characteristics of the nodes and battery units of the DES system as node specific rules are applied in deriving operating parameters that are used in activation of respective nodes. By means of various embodiments nodes may be primarily activated with more preferred operating parameters and less preferred operating parameters are used only if capacity requirement cannot be fulfilled by the more preferred operating parameters.

Various embodiments provide that in situations where less than full aggregated capacity of a DES system is needed, the nodes of the DES system can be activated with such operating parameters that minimize negative impacts on individual nodes or battery units. Less preferred operating parameters are taken into use only in situations where the required capacity exceeds the aggregated capacity achieved with more preferred operating parameters.

Any of the afore described methods, method steps, or combinations thereof, may be controlled or performed using hardware; software; firmware; or any combination thereof. The software and/or hardware may be local; distributed; centralised; virtualised; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A computer implemented method for activation of nodes in a distributed energy storage, DES, system, wherein the DES system comprises a plurality of nodes, each node comprising one or more battery units; the method comprising
defining a ruleset for the DES system, wherein the ruleset comprises for each node first rules for a more preferred combination of operating parameters and second rules for at least one less preferred combination of operating parameters;
detecting a required capacity; and
responsively activating nodes by using a combination of operating parameters derived based on the respective first rules until the required capacity is fulfilled or until all available nodes have been activated; and
detecting a need for additional capacity and responsively
adjusting the combination of operating parameters of one or more activated nodes based on the respective second rules until the additional capacity is reached; or
first increasing the amount of activated nodes, if available, and then adjusting (360) the combination of operating parameters of one or more activated nodes based on the respective second rules until the additional capacity is reached.

2. The method of claim 1, wherein detecting the need for additional capacity comprises detecting that the required capacity is not fulfilled by the activated nodes.

3. The method of claim 1, wherein the first rules and/or the second rules comprise separate rules for charging battery unit(s) of the respective node and for discharging battery unit(s) of the respective node.

4. The method of claim 1, wherein the required capacity is capacity needed for balancing of electric grid.

5. The method of claim 1, wherein the required capacity is capacity needed for load shifting.

6. The method of claim 1, wherein the operating parameters comprise one or more of: rectifier voltage, rectifier current, rectifier ramp-up settings, rectifier ramp-down settings, battery current.

7. The method of claim 1, wherein the combination of operating parameters derived based on the first rules and/or the second rules dynamically vary based on real time conditions.

8. The method of claim 7, wherein the real time conditions relate to one or more of: temperature, battery properties, and rectifier properties.

9. The method of claim 8, wherein the battery properties comprise one or more of: C-rate, state of charge, state of health, duration of possible activation.

10. An apparatus comprising means for performing the method of claim 1.

11. The apparatus of claim 10, wherein the means comprise a processor and a memory including computer program code, and wherein the memory and the computer program code are configured to, with the processor, cause the performance of the apparatus.

12. A computer program comprising non-transitory computer readable medium having computer executable program code which when executed in an apparatus causes the apparatus to perform the method of claim 1.

13. The method of claim 2, wherein the first rules and/or the second rules comprise separate rules for charging battery unit(s) of the respective node and for discharging battery unit(s) of the respective node.

14. The method of claim 2, wherein the required capacity is capacity needed for balancing of electric grid.

15. The method of claim 3, wherein the required capacity is capacity needed for balancing of electric grid.

16. The method of claim 2, wherein the required capacity is capacity needed for load shifting.

17. The method of claim 3, wherein the required capacity is capacity needed for load shifting.

18. The method of claim 4, wherein the required capacity is capacity needed for load shifting.

19. The method of claim 2, wherein the required capacity is capacity needed for load shifting.

20. The method of claim 3, wherein the required capacity is capacity needed for load shifting.
